(19) United States
(12) Patent Application Publication
(10) Pub. No.: US 2024/0337313 A1
(43) Pub. Date: Oct. 10, 2024

(54) GEAR DEVICE AND SENSOR INSTALLATION MEMBER

(71) Applicant: SUMITOMO HEAVY INDUSTRIES, LTD., Tokyo (JP)

(72) Inventors: Osamu OKAZAKI, Kanagawa (JP); Yoshihisa USAMI, Tokyo (JP)

(21) Appl. No.: 18/744,780

(22) Filed: Jun. 17, 2024

Related U.S. Application Data
(63) Continuation of application No. PCT/JP2022/037072, filed on Oct. 4, 2022.

(30) Foreign Application Priority Data
Jan. 4, 2022 (JP) 2022-000264

(51) Int. Cl. F16H 49/00; G01L 3/14

(52) U.S. Cl. CPC F16H 49/001; G01L 3/14

(57) ABSTRACT

A gear device includes an internal gear and an external gear that meshes with the internal gear; the internal gear includes an internal tooth ring portion that is provided with internal teeth on an inner periphery thereof, an outer ring portion that is provided on a radially outer side of the internal tooth ring portion, and an easily deformable portion that is provided between the internal tooth ring portion and the outer ring portion and that is adapted to be more easily deformable than the internal tooth ring portion; a strain sensor is installed on the easily deformable portion; and the easily deformable portion is adapted such that a variation range of a radial distribution of strain is small as compared to a case where the easily deformable portion is made of a single material to have a uniform axial thickness in a radial direction.

### CROSS-REFERENCE TO RELATED APPLICATIONS

This is a bypass continuation of International PCT Application No. PCT/JP2022/037072, filed on Oct. 4, 2022, which claims priority to Japanese Patent Application No. 2022-000264, filed on Jan. 4, 2022, which are incorporated by reference herein in their entirety.

### BACKGROUND

### Technical Field

Certain embodiments of the present invention relate to a gear device and a sensor installation member.

### Description of Related Art

A gear device that includes an internal gear and strain gauges installed on an outer peripheral surface of the internal gear is disclosed in the related art.

### SUMMARY

According to an aspect of the present invention, there is provided a gear device including an internal gear and an external gear that meshes with the internal gear. The internal gear includes an internal tooth ring portion that is provided with internal teeth on an inner periphery thereof, an outer ring portion that is provided on a radially outer side of the internal tooth ring portion, and an easily deformable portion that is provided between the internal tooth ring portion and the outer ring portion and that is adapted to be more easily deformable than the internal tooth ring portion; a strain sensor is installed on the easily deformable portion; and the easily deformable portion is adapted such that a variation range of a radial distribution of strain is small as compared to a case where the easily deformable portion is made of a single material to have a uniform axial thickness in a radial direction.

According to another aspect of the present invention, there is provided a sensor installation member including a sensor installation portion on which a sensor for detecting a predetermined quantity of state is to be installed. The sensor installation portion is adapted such that a variation range of a distribution of the quantity of state in a specific direction is small as compared to a case where the sensor installation portion is made of a single material such that a dimension of the sensor installation portion in a direction perpendicular to the specific direction is uniform in the specific direction, and the sensor installation portion includes a sensor installation region having a range larger than a size of the sensor and is adapted such that the sensor is installable at any position of the sensor installation region in the specific direction.

### BRIEF DESCRIPTION OF THE DRAWINGS

FIG. 1 is a side cross-sectional view of a gear device according to first embodiment.

FIG. 2 is a front view of a first internal gear of the embodiment.

FIG. 3 is a cross-sectional view taken along line A-A of FIG. 2.

FIG. 4A is a diagram showing a schematic cross-sectional shape of an easily deformable portion in a reference condition as viewed from the same viewpoint as that in FIG. 3, FIG. 4B is a diagram showing a radial distribution of a bending moment thereof, FIG. 4C is a diagram showing a radial distribution of the square of an axial thickness thereof, FIG. 4D is a diagram showing a radial distribution of a stress thereof, FIG. 4E is a diagram showing a radial distribution of a Young's modulus thereof, and FIG. 4F is a diagram showing a radial distribution of a strain thereof.

FIG. 5A is a diagram schematically showing a cross-sectional shape of an easily deformable portion of the embodiment as viewed from the same viewpoint as that in FIG. 3, FIG. 5B is a diagram schematically showing a radial distribution of a bending moment thereof, FIG. 5C is a diagram schematically showing a radial distribution of the square of an axial thickness thereof, FIG. 5D is a diagram schematically showing a radial distribution of a stress thereof, FIG. 5E is a diagram schematically showing a radial distribution of a Young's modulus thereof, and FIG. 5F is a diagram schematically showing a radial distribution of a strain thereof.

FIG. 6A is a diagram schematically showing a cross-sectional shape of an easily deformable portion of second embodiment as viewed from the same viewpoint as that in FIG. 3, FIG. 6B is a diagram schematically showing a radial distribution of a bending moment thereof, FIG. 6C is a diagram schematically showing a radial distribution of the square of an axial thickness h thereof, FIG. 6D is a diagram schematically showing a radial distribution of a stress thereof, FIG. 6E is a diagram schematically showing a radial distribution of a Young's modulus thereof, and FIG. 6F is a diagram schematically showing a radial distribution of a strain thereof.

FIG. 7A is a diagram schematically showing a cross-sectional shape of an easily deformable portion of third embodiment as viewed from the same viewpoint as that in FIG. 3, FIG. 7B is a diagram schematically showing a radial distribution of a bending moment thereof, FIG. 7C is a diagram schematically showing a radial distribution of the square of an axial thickness thereof, FIG. 7D is a diagram schematically showing a radial distribution of a stress thereof, FIG. 7E is a diagram schematically showing a radial distribution of a Young's modulus thereof, and FIG. 7F is a diagram schematically showing a radial distribution of a strain thereof.

FIG. 8 is a diagram of a first internal gear of fourth embodiment as viewed from the same viewpoint as that in FIG. 2.

### DETAILED DESCRIPTION

As a result of further studies on the technique disclosed in the related art, the present inventors have recognized the following new understanding. A variation in a detection value of a sensor occurs depending on an installation position of a strain gauge serving as a sensor. This is not limited to a case where a strain sensor, such as a strain gauge, is used as a sensor, and is a issue common to a case where a sensor for detecting a quantity of state is to be installed on a sensor installation member.

It is desirable to provide a technique for suppressing a variation in a detection value of a sensor.

Embodiments will be described below. The same components are denoted by the same reference numerals, and repeated description will be omitted. In each drawing, for the convenience of description, components will be omitted, enlarged, or reduced as appropriate. The drawings should be viewed according to the direction of a reference numeral.

### First Embodiment

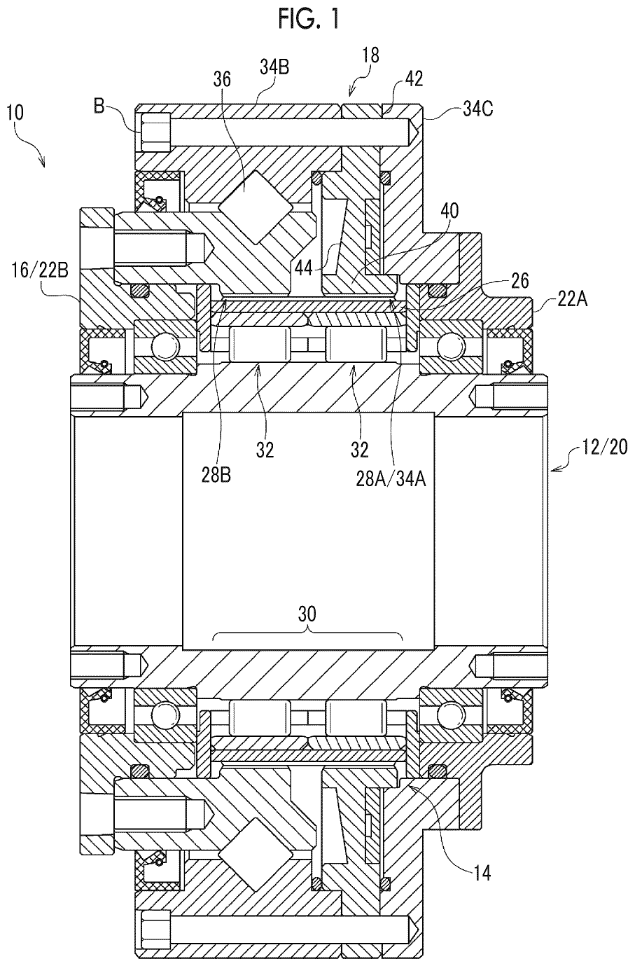

FIG. 1 will be referred to. A gear device 10 includes an input shaft 12, a gear mechanism 14 that transmits rotation of the input shaft 12, an output member 16 that extracts an output rotation from the gear mechanism 14 and that outputs the output rotation to a driven machine, and a casing 18 that accommodates the gear mechanism 14. In addition, the gear device 10 according to the present embodiment includes a wave generator shaft 20 that serves as the input shaft 12 and covers 22A and 22B that are disposed on an external gear 26 (to be described later) of the gear mechanism 14 in an axial direction. The covers 22A and 22B include a first cover 22A that is disposed on one side (a right side in FIG. 1, here, a counter-load side) of the external gear 26 in the axial direction, and a second cover 22B that is disposed on the other side (a left side in FIG. 1, here, a load side) of the external gear 26 in the axial direction. Although a specific example of the driven machine is not particularly limited, the driven machine is, for example, a conveyor, a wheel, a machine tool, a robot device, or the like.

The gear device 10 is a bending meshing type gear device. The gear mechanism 14 used in the gear device includes the external gear 26 that serves as a bending gear, and internal gears 28A and 28B that serve as meshing gears meshing with the external gear 26. The gear mechanism 14 can bend and deform the bending gear (external gear 26) with a wave generator 30 (to be described later) of the wave generator shaft 20 to rotate one of the external gear 26 and the internal gears 28A and 28B, and can extract an axial rotation component thereof from the output member 16 as an output rotation. An example in which the external gear 26 can be rotated together with the second cover 22B serving as the output member 16 is shown in the present embodiment. The gear mechanism 14 of the present embodiment is a tubular bending meshing type gear mechanism using a first internal gear 28A of which rotation relative to the casing 18 is constrained and a second internal gear 28B that is rotatable relative to the casing 18.

The wave generator shaft 20 can be rotated by rotational power transmitted from a drive source (not shown). The drive source is, for example, a motor, a gear motor, an engine, or the like.

The wave generator shaft 20 includes a wave generator 30 that bends and deforms the external gear 26 (bending gear). The wave generator 30 has a stiffness that allows the bending gear to be bent and deformed by its own rotation. An outer peripheral shape of the wave generator 30 is an elliptical shape in a cross-section perpendicular to an axial direction of the wave generator shaft 20. The term “elliptical” used in this specification is not limited to geometrically exactly “elliptical”, but also includes substantially “elliptical”.

The external gear 26 serving as the bending gear is a tubular member having flexibility. The external gear 26 serving as the bending gear is supported to be rotatable relative to the wave generator 30 via wave generator bearings 32.

The internal gears 28A and 28B serving as the meshing gears have a stiffness to an extent that the internal gears 28A and 28B are not deformed in accordance with the rotation of the wave generator 30. The first internal gear 28A has a number of internal teeth (for example, 102) different from the number of external teeth (for example, 100) of the external gear 26, and the second internal gear 28B has the same number of internal teeth as the number of external teeth of the external gear 26.

The casing 18 of the present embodiment includes a first casing member 34A that also serves as the first internal gear 28A, a second casing member 34B that is disposed on a radially outer side of the second internal gear 28B, and a third casing member 34C that is disposed on a side opposite to the second casing member 34B with the first casing member 34A interposed therebetween. The respective casing members 34A, 34B, and 34C are integrated with each other by bolts B. The casing 18 is fixed to a fixed member (not shown) provided outside the gear device 10. A main bearing 36 that allows the second casing member 34B and the second internal gear 28B to rotate relative to each other is disposed between the second casing member 34B of the casing 18 and the second internal gear 28B.

The first cover 22A is connected to the casing 18 with bolts, press-fitting, or the like, and is integrated with the casing 18. The second cover 22B is connected to the second internal gear 28B with bolts, press-fitting, or the like, and is integrated with the second internal gear 28B.

An operation of the gear device 10 described above will be described. In a case where the input shaft 12 is rotated by the drive source, the gear mechanism 14 operates. In a case where the gear mechanism 14 operates, an output rotation that is changed in speed (reduced in speed in the present embodiment) with respect to the rotation of the input shaft 12 is extracted from the gear mechanism 14 through the output member 16.

In the present embodiment, the external gear 26 is bent and deformed to have an elliptical shape corresponding to the shape of the wave generator 30 in a case where the wave generator 30 of the wave generator shaft 20 rotates. In a case where the external gear 26 is bent and deformed as described above, meshing positions between the external gear 26 and the internal gears 28A and 28B are changed in a rotation direction of the wave generator 30. In this case, whenever the meshing position between the external gear 26 and the first internal gear 28A having different numbers of teeth makes one rotation, the meshing teeth of the external gear 26 and the first internal gear 28A are shifted in a circumferential direction. As a result, one (in the present embodiment, the external gear 26) of these rotates, and the axial rotation component thereof is extracted from the output member 16 as an output rotation. In the present embodiment, the external gear 26 and the second internal gear 28B are synchronized with each other due to having the same number of teeth, and the axial rotation component of the external gear 26 is extracted from the second cover 22B serving as the output member 16 through the second internal gear 28B synchronized with the external gear 26.

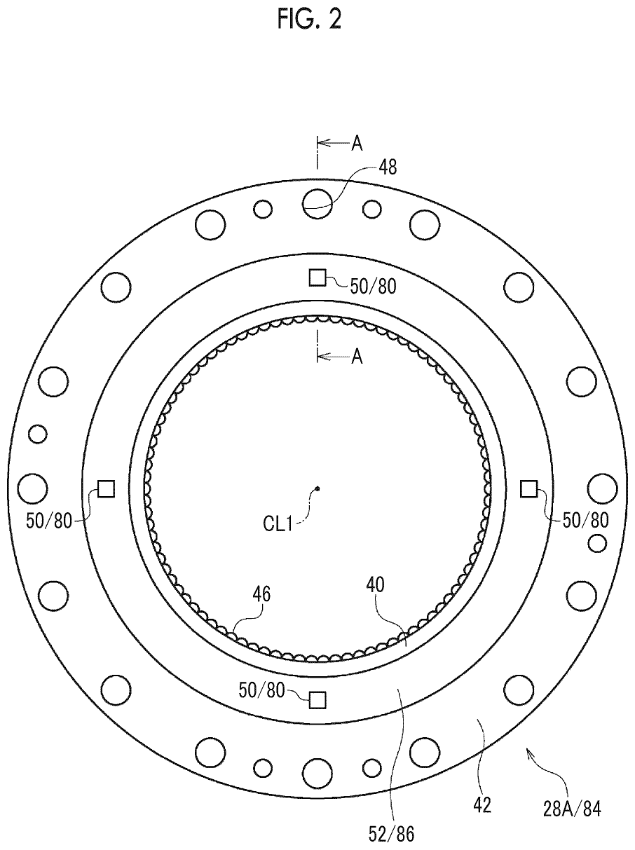

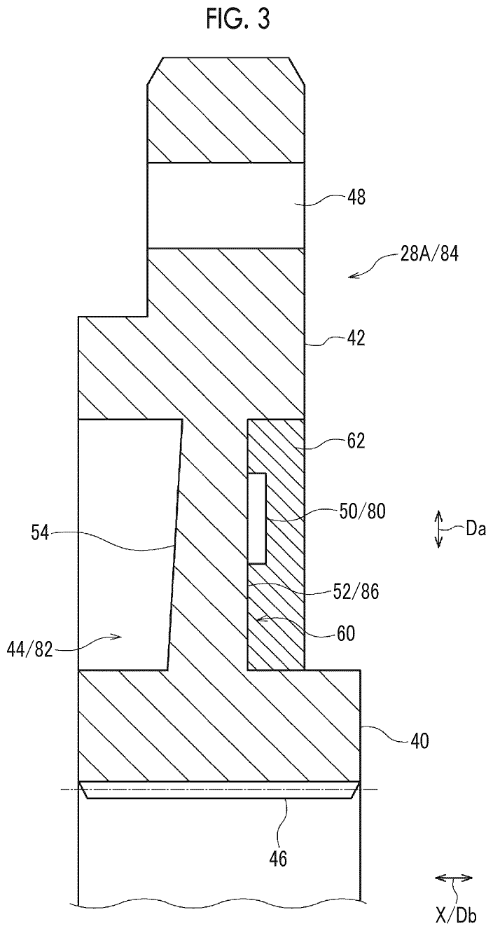

FIGS. 2 and 3 will be referred to. A protection material 62 to be described later is not shown in FIG. 2. Hereinafter, a direction along an axial center CL1 of the first internal gear 28A will be defined as an axial direction X, and a radial direction and a circumferential direction of a circle concentric with the axial center CL1 will be simply referred to as a radial direction and a circumferential direction.

The first internal gear 28A includes an internal tooth ring portion 40, an outer ring portion 42 that is provided on a radially outer side of the internal tooth ring portion 40, and an easily deformable portion 44 that is provided between the internal tooth ring portion 40 and the outer ring portion 42.

The internal tooth ring portion 40 has a ring shape, and internal teeth 46 to mesh with the external gear 26 are provided on an inner periphery thereof.

The outer ring portion 42 has a ring shape, and is integrated with a fixed member provided outside the gear device 10. The outer ring portion 42 of the present embodiment is connected to the other casing members 34B and 34C of the casing 18 with the bolts B, and is integrated with the fixed member via the casing members 34B and 34C (see FIG. 1). In addition, the outer ring portion 42 may be directly integrated with the fixed member, or may be integrated with the fixed member via another member (for example, the first cover 22A). Through-holes 48 into which the bolts B to be connected to the casing members 34B and 34C are to be inserted are formed in the outer ring portion 42 of the present embodiment at intervals in the circumferential direction.

The easily deformable portion 44 is connected to an outer periphery of the internal tooth ring portion 40 and is connected to an inner periphery of the outer ring portion 42. The easily deformable portion 44 is adapted to be more easily deformable in the circumferential direction than the internal tooth ring portion 40 in a case where torque is applied to the internal tooth ring portion 40 due to meshing between the external gear 26 and the internal tooth ring portion 40 in a state where the outer ring portion 42 is integrated with the fixed member. In such a case, it can be said that the amount of deformation of the easily deformable portion 44 in the circumferential direction is larger than that of the internal tooth ring portion 40. The easily deformable portion 44 of the present embodiment has an axial thickness smaller than that of the outer ring portion 42, but may have an axial thickness equal to or larger than that of the outer ring portion 42. In addition, the easily deformable portion 44 of the present embodiment has an axial thickness smaller than that of the internal tooth ring portion 40, but may have an axial thickness equal to or larger than that of the internal tooth ring portion 40. The easily deformable portion 44 of the present embodiment has a ring shape. The easily deformable portion 44 of the present embodiment has the shape of a ring that is continuous over the entire circumference in the circumferential direction without hole portions penetrating in the axial direction X.

Strain sensors 50 for detecting a strain of the easily deformable portion 44 (in the present embodiment, a strain in which a strain in the circumferential direction and a strain in the radial direction are combined) are installed on the easily deformable portion 44 of the first internal gear 28A. The strain sensor 50 of the present embodiment is a strain gauge. In addition, the strain sensor 50 may be, for example, a piezoelectric element or the like. The strain sensor 50 can detect the amount of strain of the easily deformable portion 44 in a case where the easily deformable portion 44 is deformed in the circumferential direction as described above. The strain sensors 50 of the present embodiment are installed on the easily deformable portion 44 at positions arranged at regular angular intervals in the circumferential direction. The number of the strain sensors 50 and intervals at which the strain sensors 50 are arranged in the circumferential direction are not particularly limited.

The strain detected by the strain sensor 50 is used, for example, to calculate torque applied to the internal tooth ring portion 40 of the first internal gear 28A. Specifically, the strain sensor 50 is electrically connected to a calculation device (not shown) that calculates torque. The calculation device is a combination of a CPU, such as a microcomputer, a ROM, and a RAM. In a case where the strain sensor 50 acquires a signal indicating the amount of strain, the strain sensor 50 outputs the acquired signal to the calculation device. There is a correlation between the strain detected by the strain sensor 50 and the torque applied to the first internal gear 28A. The calculation device can calculate the torque from the detected strain with reference to a relational expression or a relational table that defines a correlation between the strain and the torque.

The strain sensors 50, which are strain gauges, are wired to form a bridge circuit (not shown) in accordance with a predetermined wiring method (a one-gauge method, a two-gauge method, a four-gauge method, or the like). Here, a wiring method, which is a four-gauge method using four strain gauges, will be exemplified. In addition, any one of a one-gauge method using one strain gauge, a two-gauge method using two strain gauges, and the like may be used as this wiring method. A strain acting on the strain sensor 50 is output to the calculation device as a voltage signal indicating the amount of strain via the bridge circuit.

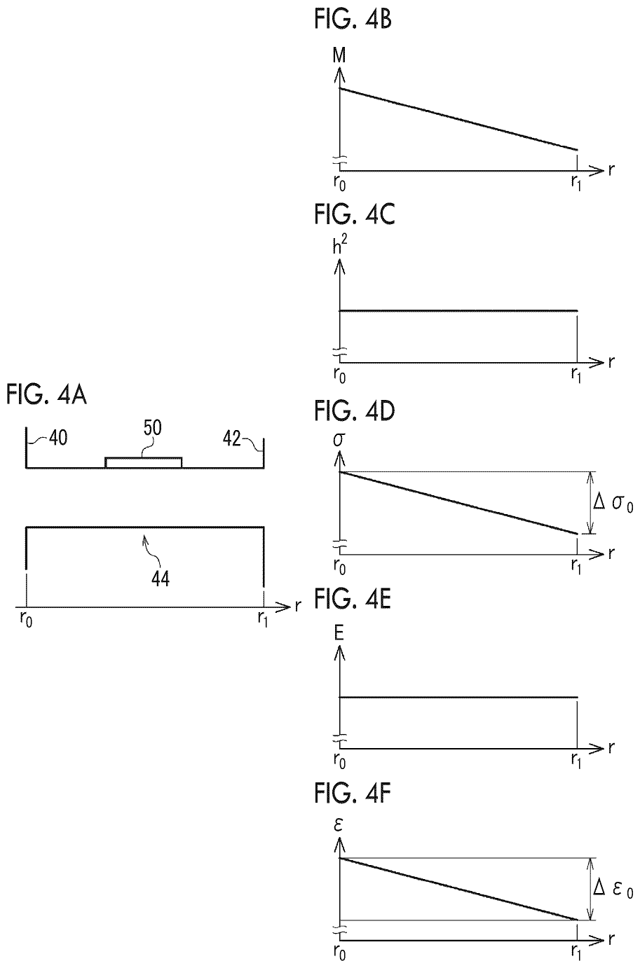

FIGS. 4A to 4F will be referred to. A case where the easily deformable portion 44 of the first internal gear 28A is made of a single material to have a uniform axial thickness h [mm] (hereinafter, simply referred to as a thickness h) in the radial direction is referred to as a reference condition. Due to being made of a single material in a case where the easily deformable portion 44 is in the reference condition, the easily deformable portion 44 has a uniform Young's modulus E [MPa] in the radial direction.

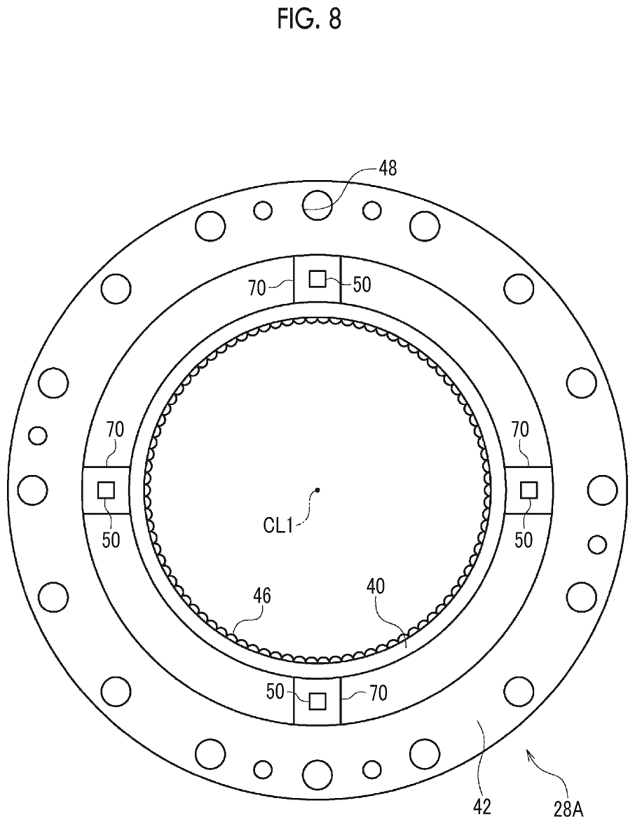

In a case where the easily deformable portion 44 of the first internal gear 28A is in the reference condition, conditions other than the material and the thickness of the easily deformable portion 44 are common to conditions of a comparison source in the determination of a variation range Δϵ of the radial distribution of a strain ϵ to be described below. For example, structures of the internal tooth ring portion 40 and the outer ring portion 42 of the first internal gear 28A are common between the reference condition and the condition of the comparison source. Further, a method of integrating the outer ring portion 42 with the fixed member is also common between the reference condition and the condition of the comparison source in addition to a magnitude of torque applied to the internal tooth ring portion 40. Furthermore, a shape other than the thickness h of the easily deformable portion 44, that is, the shape of the easily deformable portion 44 viewed in the axial direction, is common between the reference condition and the condition of the comparison source. For example, in a case where the easily deformable portion 44 has a ring shape as in the present embodiment, the easily deformable portion 44 has a ring shape having a common shape as viewed in the axial direction, in both a structure in the reference condition and a structure of the comparison source. In addition, in a case where the easily deformable portion 44 is a plurality of pillar portions 70 (see FIG. 8) as in an embodiment to be described later, the plurality of pillar portions 70 forming the easily deformable portion 44 have a common shape as viewed in the axial direction, in both the structure in the reference condition and the structure of the comparison source.

In a case where torque is applied to the internal tooth ring portion 40 of the first internal gear 28A due to meshing between the first internal gear 28A and the external gear 26, a bending moment M [Nm] acts on the easily deformable portion 44 of the first internal gear 28A. The bending moment M has a radial distribution in which the bending moment is continuously reduced from a radially inner side of the first internal gear 28A toward a radially outer side thereof (see FIG. 4B). As an example, the bending moment M has a radial distribution in which the bending moment is proportional to a distance r from the axial center CL1 of the first internal gear 28A with a negative slope.

A stress σ (bending stress) [N/m²] on a side surface of the easily deformable portion 44 of the first internal gear 28A in the axial direction (installation surface 52 to be described later) in a cross-section perpendicular to the radial direction at a position corresponding to the distance r and a section modulus Z [m³] in the cross-section are assumed. In general, the stress σ depends on the bending moment M and the section modulus Z. The stress σ is reduced as the bending moment M is reduced and is increased as the section modulus Z is reduced. As an example, the stress σ has a value that is proportional to a product of the bending moment M and an inverse number of the section modulus Z with a positive slope. For example, in a case where the easily deformable portion 44 is in the reference condition, it is assumed that the width of the easily deformable portion 44 in a direction, which is perpendicular to the radial direction and the axial direction, in a cross-section perpendicular to the radial direction is constant. In this case, since the radial distribution of the section modulus Z in a cross-section perpendicular to the radial direction is uniform, the stress σ has a radial distribution in which the stress σ is continuously reduced from the radially inner side to the radially outer side as with the radial distribution of the bending moment M (see FIG. 4D). An example in which the stress σ has a radial distribution proportional to the distance r with a negative slope as with the bending moment M is shown here.

Further, a strain ϵ[−] on a side surface of the easily deformable portion 44 in the axial direction in a cross-section perpendicular to the radial direction at a position corresponding to the distance r in a case where the bending moment M acts, and a Young's modulus E [Mpa] in the cross-section are assumed. In general, the strain ϵ depends on the stress o and the Young's modulus E. The strain ϵ is reduced as the stress σ is reduced and is increased as the Young's modulus E is reduced. As an example, the strain ϵ has a value that is proportional to a product of the stress σ and an inverse number of the Young's modulus E with a positive slope. For example, in a case where the easily deformable portion 44 is in the reference condition, it is assumed that the width of the easily deformable portion 44 in a direction, which is perpendicular to the radial direction and the axial direction, in a cross-section perpendicular to the radial direction is constant. In this case, since the radial distribution of the Young's modulus E in a cross-section perpendicular to the radial direction is uniform, the strain ϵ has a radial distribution in which the strain ϵ is continuously reduced from the radially inner side to the radially outer side as with the radial distribution of the stress σ (see FIG. 4F). An example in which the strain ϵ has a radial distribution proportional to the distance r with a negative slope as with the bending moment M is shown here.

As a result, in a case where the easily

deformable portion 44 is in the reference condition and the bending moment M is reduced toward the radially outer side, the strain ϵ is reduced by the amount of reduction in the bending moment M, and the variation range Δϵ of the strain ϵ is increased by the amount of reduction in the strain ϵ. The variation range (here, Δϵ) of the radial distribution mentioned here refers to a difference value between a maximum value and a minimum value of an object to be mentioned in the radial direction. An example in which the strain ϵ has a maximum value at an inner peripheral end portion of the easily deformable portion 44 present at a position corresponding to a distance r0 and the strain ϵ has a minimum value at an outer peripheral end portion of the easily deformable portion 44 present at a position corresponding to a distance r1 is shown here. Hereinafter, 0 (for example, Δϵ0) is added to an end of a variation range of a structure in the reference condition, and 1 (for example, Δϵ1) is added to an end of a variation range of a structure of the embodiment. Further, the variation mentioned here does not refer to a variation relating to an error of a measured value, but refers to a variation relating to a distribution of a quantity of state (here, a strain) measured by a sensor (here, the strain sensor 50). In a case where the installation position of the strain sensor 50 is changed in the radial direction, a detection value of the strain sensor 50 varies by an amount corresponding to the variation range Δϵ of the radial distribution of the strain ϵ. As described below, the easily deformable portion 44 of the first internal gear 28A of the present embodiment is adapted such that the variation range Δϵ of the radial distribution of the strain ϵ is reduced as compared to a case where the easily deformable portion 44 is in the reference condition.

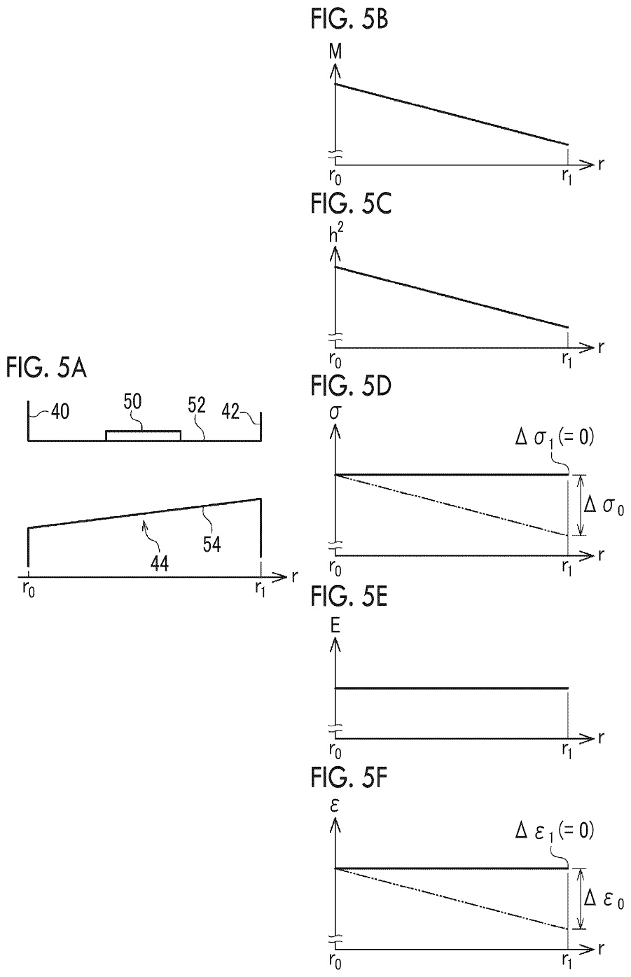

FIGS. 5A to 5F will be referred to. As described above, the stress o in a case where the bending moment M acts at a position corresponding to the distance r depends on the bending moment M and the section modulus Z. In general, the section modulus Z of any cross-section depends on the thickness h of the cross-section, and is increased as the thickness h is increased. In summary, the stress σ depends on the bending moment M and the thickness h, is reduced as the bending moment M is reduced, and is increased as the thickness h is reduced. As an example, the stress σ has a value that is proportional to a product of the bending moment M and an inverse number of the square of the thickness h with a positive slope.

In a case where the bending moment M is reduced toward the radially outer side and the thickness h is uniform in the radial direction (in a case where the easily deformable portion 44 is in the reference condition), the stress o is reduced by an amount corresponding to the amount of reduction in the bending moment M, and a variation range Δσ of the stress σ (by extension, Δϵ) is increased by the amount of reduction in the stress σ (see FIGS. 4D and 4F). Here, the thickness h of the easily deformable portion 44 of the present embodiment is gradually reduced from the radially inner side to the radially outer side so that at least a part of the amount of reduction in the stress σ accompanying the reduction of the bending moment M is compensated for (that is, returns to an original state) (see FIGS. 5A and 5C). Accordingly, the amount of reduction in the stress σ can be reduced as compared to a case where the thickness h is made uniform in the radial direction (a case where the easily deformable portion 44 is in the reference condition), so that the variation range Δσ of the stress σ can be reduced (see FIG. 5D). Eventually, since the variation range Δσ of the stress σ is reduced, the variation range Δσ of the radial distribution of the strain ϵ can also be reduced as compared to a case where the easily deformable portion 44 is in the reference condition (see FIG. 5F). In other words, it can be said that the thickness h of the easily deformable portion 44 is changed in the radial direction so that the variation range Δσ of the stress σ (the variation range Δϵ of the strain ϵ) is reduced as compared to a case where the easily deformable portion 44 is in the reference condition.

In a case where the thickness h is to be gradually reduced toward the radially outer side, the thickness h of the easily deformable portion 44 of the present embodiment is continuously reduced so that the entire amount of reduction in the stress σ accompanying the reduction of the bending moment M is compensated for. In a case where the entire amount of reduction in the stress σ is to be compensated for in this way, the thickness h of the easily deformable portion 44 of the present embodiment is continuously reduced in accordance with the reduction of the bending moment M so that a product of the bending moment M having a dependency on the stress σ and an inverse number of the square of the thickness h is kept constant. For the convenience of description, the thickness h and the distance r are shown in FIG. 5A to be in a linear relationship. However, in a case where the thickness h is reduced as described above, the square of the thickness h and the distance r are actually in a linear relationship as shown in FIG. 5C. Accordingly, the radial distribution of the stress σ can be made uniform, and the variation range Δσ of the stress σ can be set to zero (see FIG. 5D). Eventually, the radial distribution of the strain ϵ can be made uniform, and the variation range Δϵ of the strain ϵ can be set to zero (see FIG. 5F).

In a case where the variation range Δϵ of the radial distribution of the strain ϵ is to be reduced as described above, it is preferable that the variation range Δϵ is small as compared to a case where the easily deformable portion 44 is in the reference condition. For example, it is preferable to set the variation range Δϵ to a variation range Δϵ1 of ½ or less of a variation range Δϵ0 obtained in a case where the easily deformable portion 44 is in the reference condition, and it is more preferable to set the variation range Δϵ to a variation range Δϵ1 of ⅕ or less of the variation range Δϵ0.

The thickness h is gradually reduced from the radially inner side to the radially outer side in this way, so that the thickness h of the easily deformable portion 44 is the largest at an inner peripheral end portion of the easily deformable portion 44 and is the smallest at an outer peripheral end portion thereof. Accordingly, it is possible to suppress an increase in a local strain at the inner peripheral end portion of the easily deformable portion 44 where the bending moment M is the largest as compared to a case where the thickness of the easily deformable portion 44 is the same as the thickness of the outer peripheral end portion and is uniform in the radial direction.

The easily deformable portion 44 described above includes an installation surface 52 on which the strain sensors 50 are to be installed, and an opposite surface 54 that is positioned on a side opposite to the installation surface 52 in the axial direction. The installation surface 52 of the easily deformable portion 44 is perpendicular to the axial direction, and the opposite surface 54 thereof is inclined with respect to the axial direction. The opposite surface 54 is formed to be continuously close to the installation surface 52 toward the radially outer side. Since the opposite surface 54 of the easily deformable portion 44 is inclined with respect to the axial direction, the thickness h is continuously reduced from the radially inner side to the radially outer side. In the present embodiment, the installation surface 52 and the opposite surface 54 are formed of flat surfaces without irregularities. Specific examples of the installation surface 52 and the opposite surface 54 are not limited thereto, and, for example, the installation surface 52 and the opposite surface 54 may include a recessed portion or a protrusion or may be provided with a through-hole.

Effects of the features described above will be described.

The easily deformable portion 44 is adapted so that the variation range Δϵ of the radial distribution of the strain ϵ is small as compared to a case where the easily deformable portion 44 is in the reference condition. Accordingly, even though the installation position of the strain sensor on the easily deformable portion 44 is changed in the radial direction, a variation in the detection value (strain) of the strain sensor 50 can be suppressed. Therefore, it is possible to relax the required accuracy of the installation position of the strain sensor 50 in the radial direction that is required to suppress a variation in the detection value of the strain sensor 50.

The easily deformable portion 44 is adapted such that the axial thickness is changed in the radial direction to make the variation range Δϵ of the radial distribution of the strain ϵ small as compared to a case where the easily deformable portion 44 is in the reference condition. Accordingly, the variation range Δϵ of the radial distribution of the strain ϵ can be easily reduced by simple means, such as changing the radial distribution of the axial thickness of the easily deformable portion 44.

Further, the easily deformable portion 44 is adapted such that the axial thickness is gradually changed from the radially inner side to the radially outer side to make the variation range Δϵ of the radial distribution of the strain a small. Accordingly, the variation range Δϵ of the radial distribution of the strain & can be more easily reduced by simpler means, such as gradually changing the axial thickness.

A case where the first internal gear 28A is disposed on a flat surface of a workbench for work for installing the strain sensors 50 will be considered. The installation surface 52 of the easily deformable portion 44 of the present embodiment is perpendicular to the axial direction. Accordingly, in a case where the first internal gear 28A is disposed such that the axial center CL1 of the first internal gear 28A and a normal direction of the flat surface of the workbench are aligned with each other, a distance from the flat surface of the workbench to the installation surface 52 in the normal direction can be made constant regardless of positions on the first internal gear 28A in the circumferential direction and the radial direction. Eventually, since a position of the installation surface 52 located at a certain distance from the flat surface of the workbench can be easily identified, work for installing the strain sensors 50 on the installation surface 52 can be easily performed. Further, since the opposite surface 54 of the easily deformable portion 44 is inclined with respect to the axial direction, the thickness h can be continuously reduced from the radially inner side to the radially outer side as described above.

The easily deformable portion 44 of the present embodiment has the shape of a ring that is continuous in the circumferential direction. Accordingly, stress acting on the easily deformable portion 44 can be reduced and high allowable stress can be ensured, as compared to a case where the easily deformable portion 44 is formed of a plurality of pillar portions 70 arranged at intervals in the circumferential direction.

Next, other features of the gear device 10 will be described. FIG. 3 will be referred to. The first internal gear 28A includes a recessed portion 60 that is provided on the easily deformable portion 44 and that is recessed in the axial direction. The recessed portion 60 is provided between the outer ring portion 42 and the internal tooth ring portion 40, and the installation surface 52 of the easily deformable portion 44 is provided on a bottom portion of the recessed portion 60. The recessed portion 60 is recessed from the outer ring portion 42 and the internal tooth ring portion 40 in the axial direction.

The gear device 10 includes a protection material 62 in which the strain sensors 50 are buried. The protection material 62 plays a role of protecting the strain sensors 50. The protection material 62 of the present embodiment isolates the strain sensors 50 from an external space around the first internal gear 28A to protect the strain sensors 50 from humidity in the external space. In this case, the protection material 62 is formed of a coating material having moisture resistance. In addition, the protection material 62 may protect the strain sensors 50 from, for example, dirt and the like in the external space.

The protection material 62 is provided on the easily deformable portion 44 of the first internal gear 28A by coating or the like. The protection material 62 is provided in the recessed portion 60, and at least a part of the recessed portion 60 is filled with the protection material 62. The protection material 62 is formed of a material that allows the easily deformable portion 44 to be deformed. In order to realize this, the protection material 62 is formed of, for example, a semi-solid having fluidity or an elastic body. The semi-solid is, for example, wax, clay, or the like, and the elastic body is, for example, rubber or the like.

The above-mentioned protection material 62 in which the strain sensors 50 are buried is provided on the ring-shaped easily deformable portion 44. Accordingly, the ring-shaped easily deformable portion 44 can prevent the protection material 62 from flowing out in the axial direction X as compared to a case where the easily deformable portion 44 is formed of the plurality of pillar portions 70 arranged at intervals in the circumferential direction. Eventually, good workability can be obtained in a case where the protection material 62 is to be provided on the easily deformable portion 44.

The protection material 62 is provided in the recessed portion 60 provided on the easily deformable portion 44 having a ring shape. Accordingly, the protection material 62 is easily held in the recessed portion 60 in a case where the protection material 62 is provided on the easily deformable portion 44 by coating or the like, and it is easy to avoid a situation where the protection material 62 unintentionally adheres to other portions of the first internal gear 28A outside the recessed portion 60. Eventually, good workability can be obtained in a case where the protection material 62 is to be provided on the easily deformable portion 44.

### Second Embodiment

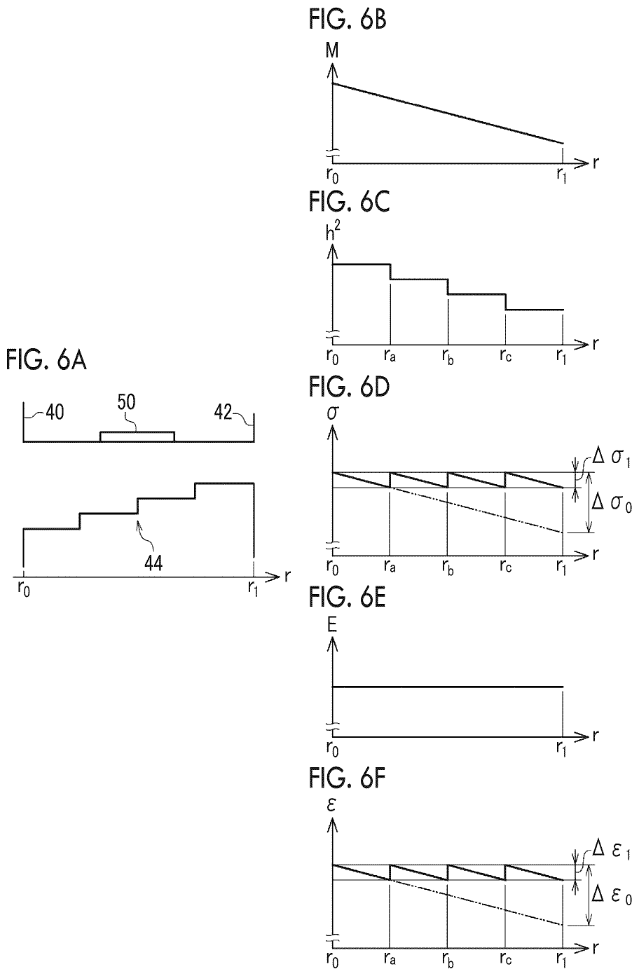

FIGS. 6A to 6F will be referred to. An example in which the thickness h is continuously reduced in a case where the thickness h is to be gradually reduced so that at least a part of the amount of reduction in the stress o accompanying the reduction of the bending moment M is compensated for has been described so far in FIGS. 5A to 5F. In addition, likewise, the thickness h may be reduced stepwise in a case where the thickness h is to be gradually reduced (see FIG. 6C). In this case, at a portion having the same thickness h (for example, a portion corresponding to a distance of r0 to ra), the stress σ is continuously reduced toward the radially outer side as the bending moment M is reduced. Further, since the stress σ is discontinuously increased at portions where the thickness h is changed (for example, portions corresponding to distances of ra, rb, and rc), a part of the amount of reduction in the stress σ accompanying the reduction of the bending moment M is compensated for, that is, returns to an original state (see FIG. 6D). It can be said that the same relationship as the relationship between the thickness h and the stress σ is satisfied even between the thickness h and the strain ϵ (see FIG. 6F). As a result, the variation range Δσ (Δϵ) of the entire radial distribution of the stress σ (strain ϵ) can be reduced as compared to a case where the easily deformable portion 44 is in the reference condition corresponding to the radial distribution of the stress σ (strain ϵ) that is continuously reduced toward the radially outer side.

### Third Embodiment

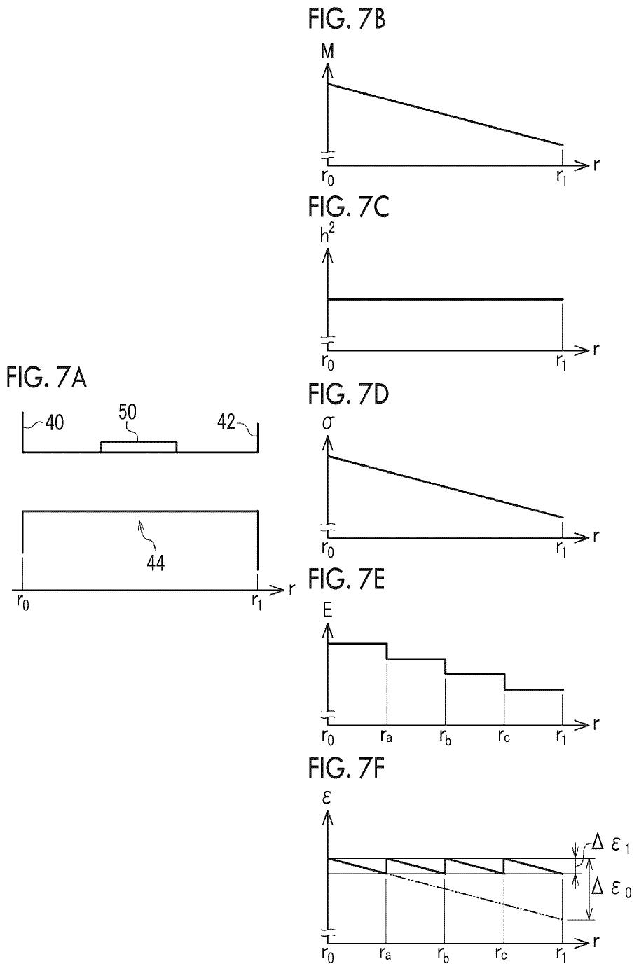

FIGS. 7A to 7F will be referred to. An example in which the thickness h is changed in the radial direction so that the variation range Δϵ of the radial distribution of the strain ϵ is reduced as compared to a case where the easily deformable portion 44 is in the reference condition has been described so far. An example in which the Young's modulus E is changed in the radial direction so that the variation range Δϵ of the radial distribution of the strain ϵ is reduced as compared to a case where the easily deformable portion 44 is in the reference condition will be described in the present embodiment. An example in which the thickness h is made uniform without being changed in the radial direction will be described in the present embodiment (see FIG. 7C).

As described above, the strain ϵ in a case where the bending moment M acts at a position corresponding to the distance r depends on the stress σ acting on a cross-section perpendicular to the radial direction at a position corresponding to the distance r and a Young's modulus E in the cross-section, is reduced as the stress σ is reduced, and is increased as the Young's modulus E is reduced. Further, as described above, the stress σ depends on the bending moment M, and is reduced as the bending moment M is reduced. In summary, the strain ϵ depends on the bending moment M and the Young's modulus E, is reduced as the bending moment M is reduced, and is increased as the Young's modulus E is reduced.

In a case where the bending moment M is reduced toward the radially outer side and the Young's modulus E is uniform in the radial direction (in a case where the easily deformable portion 44 is in the reference condition), the strain ϵ is reduced by an amount corresponding to the amount of reduction in the bending moment M, and a variation range Δϵ of the strain ϵ is increased by the amount of reduction in the strain ϵ (see FIG. 4F). Here, the Young's modulus E of the easily deformable portion 44 of the present embodiment is gradually reduced from the radially inner side to the radially outer side so that at least a part of the amount of reduction in the strain ϵ accompanying the reduction of the bending moment M is compensated for (that is, returns to an original state) (see FIG. 7E). Accordingly, the amount of reduction in the strain ϵ can be reduced as compared to a case where the Young's modulus E is made uniform in the radial direction (a case where the easily deformable portion 44 is in the reference condition), so that the variation range Δϵ of the strain ϵ can be reduced (see FIG. 7F). In other words, it can be said that the Young's modulus E of the easily deformable portion 44 is changed in the radial direction so that the variation range Δϵ of the strain ϵ is reduced as compared to a case where the easily deformable portion 44 is in the reference condition.

In a case where the Young's modulus E of the easily deformable portion 44 of the present embodiment is to be gradually reduced toward the radially outer side, the Young's modulus E of the easily deformable portion 44 is reduced stepwise so that a part of the amount of reduction in the strain ϵ accompanying the reduction of the bending moment M is compensated for. In this case, at a portion having the same Young's modulus E (for example, a portion corresponding to a distance of r0 to ra), the strain ϵ is continuously reduced toward the radially outer side. Further, since the strain ϵ is discontinuously increased at portions where the Young's modulus E is changed (for example, portions corresponding to distances of ra, rb, and rc), a part of the amount of reduction in the strain ϵ accompanying the reduction of the bending moment M is compensated for, that is, returns to an original state. As a result, the variation range Δϵ of the entire radial distribution of the strain ϵ can be reduced as compared to a case where the easily deformable portion 44 is in the reference condition corresponding to the radial distribution of the strain ϵ that is continuously reduced toward the radially outer side. In addition, in a case where the Young's modulus E is to be gradually reduced toward the radially outer side, the Young's modulus E may be continuously reduced toward the radially outer side as in the embodiment.

In a case where the Young's modulus E is to be changed in the radial direction as described above, for example, the easily deformable portion 44 may be made of composite materials having different Young's moduli E, and the amounts of some materials of the composite materials may be adjusted to change the radial distribution of the Young's modulus E of the easily deformable portion 44 as a whole. This is assumed, for example, in a case where the easily deformable portion 44 is formed of an insert molding product and the amounts of insert materials (a fiber material and the like) to be inserted into a base material are adjusted. In addition, the easily deformable portion 44 may be made of a plurality of materials or a single material, and the radial distribution of the Young's modulus E of the material itself may be changed.

An example in which one of the thickness h and the Young's modulus E is changed in the radial direction so that at least a part of the amount of reduction in the stress σ or the strain ϵ accompanying the reduction of the bending moment M is compensated for has been described so far. The present invention is not limited thereto, and both the thickness h and the Young's modulus E may be changed in the radial direction so that at least a part of the stress σ or the strain ϵ is compensated for.

### Fourth Embodiment

FIG. 8 will be referred to. A gear device 10 according to the present embodiment is different from the gear device according to the embodiment in terms of the configuration of an easily deformable portion 44. Specifically, the easily deformable portion 44 is a plurality of pillar portions 70 provided at intervals in the circumferential direction. The plurality of pillar portions 70 of the present embodiment linearly extend in the radial direction. The specific configuration of the plurality of pillar portions 70 is not particularly limited, and the plurality of pillar portions 70 may extend in the shape of, for example, a crank. Although an example in which the number of the pillar portions 70 is four is shown, the number of the pillar portions is not particularly limited.

### Description of Embodiment from Another Viewpoint

The first internal gear 28A described so far will be described from another viewpoint. FIGS. 3 and 5 will be referred to. The first internal gear 28A has been described so far as an example of a sensor installation member 84 including a sensor installation portion 82 on which sensors 80 for detecting a strain as a predetermined quantity A of state are to be installed. In the embodiments, the sensor 80 mentioned here is the strain sensor 50, and the sensor installation portion 82 is the easily deformable portion 44.

Further, an example in which a distribution of a quantity A of state, which is detected by the sensor 80, in a first specific direction Da varies in a case where the sensor installation portion 82 is made of a single material such that a dimension of the sensor installation portion 82 in a second specific direction Db perpendicular to the first specific direction Da is uniform in the first specific direction Da (that is, a case where the sensor installation portion 82 satisfies a reference condition) and in a case where the sensor installation portion 82 is in a predetermined use environment has been described. In the embodiments, the first specific direction Da mentioned here is the radial direction, and the second specific direction Db is the axial direction X. Furthermore, in the embodiments, the “predetermined use environment” mentioned here refers to a use environment during the operation of the gear device 10 in which the outer ring portion 42 of the first internal gear 28A is integrated with a fixed member and torque is applied to the internal tooth ring portion 40. In addition, in the embodiments, a fact that the distribution of the quantity A of state in the first specific direction Da varies means that the radial distribution of the strain ϵ shown in FIG. 4F has a variation in the variation range Δϵ.

Further, an example in which the variation range ΔA (Δϵ in the embodiments) of the distribution of the quantity A of state, which is detected by the sensor 80, in the first specific direction Da is small as compared to a case where the sensor installation portion 82 satisfies the reference condition has been described. Furthermore, an example in which the distribution of a parameter, which relates to the sensor installation portion 82 having a dependency on the quantity of state (the strain ϵ in the embodiments), in the first specific direction Da is adjusted in a case where the variation range ΔA of the distribution of the quantity A of state of the sensor installation portion 82 mentioned here in the first specific direction Da is to be reduced has been described. In the embodiments, the “parameter” mentioned here refers to the thickness h and the Young's modulus E of the easily deformable portion 44 (the sensor installation portion 82).

In addition, an example in which the easily deformable portion 44 of the first internal gear 28A includes a sensor installation region 86 in which the sensors 80 are to be installed has been described. In the embodiments, the sensor installation region 86 mentioned here is the installation surface 52 of the easily deformable portion 44. The sensor installation region 86 has a range larger than a size of the sensor 80. “Having a range larger than the size of the sensor 80” mentioned here means that the range of the sensor installation region 86 (the installation surface 52) is larger than an outer shape of the sensor 80 as viewed in a normal direction passing through the sensor installation region 86 (see FIG. 2). A corner formed by surfaces in the sensor installation portion 82 is excluded from the sensor installation region 86. The sensor installation portion 82 is adapted such that the sensor 80 can be installed at any position of the sensor installation region 86 in the first specific direction Da (the radial direction in the embodiment).

As described above, the sensor installation portion 82 of the sensor installation member 84 is adapted such that the variation range ΔA of the distribution of the quantity A of state in the first specific direction Da is small as compared to a case where the sensor installation portion 82 is in the reference condition. Accordingly, even in a case where the installation position of the sensor 80 in the sensor installation region 86 of the sensor installation portion 82 is changed in the radial direction, a variation in the detection value (quantity of state) of the sensor 80 can be suppressed. Therefore, it is possible to relax the required accuracy of the installation position of the sensor 80 in the first specific direction Da that is required to suppress a variation in the detection value of the sensor 80. In addition, since the sensor 80 can be installed at any position of the sensor installation region 86 in the first specific direction Da, good workability can be obtained in a case where the sensor 80 is to be installed.

A combination of the sensor installation member 84 and the sensor 80 is not particularly limited in a case where such an effect is to be obtained. For example, the sensor 80 may be a temperature sensor, an acceleration sensor, or the like in addition to the strain sensor 50.

For example, an example in which a temperature sensor is used as the sensor 80 and the casing 18 is used as the sensor installation member 84 will be described. Here, an example in which a tubular portion of the casing 18 is the sensor installation portion 82, an outer peripheral surface of the casing 18 is the sensor installation region 86, an axial direction X is the first specific direction Da, and a radial direction is the second specific direction Db will be described. As described above, a distribution of the quantity A of state (a temperature to be described later), which is detected by the sensor 80, in the first specific direction Da (the axial direction X) varies in a case where the sensor installation portion 82 satisfies the reference condition and in a case where the sensor installation portion 82 is in a predetermined use environment.

In a case where a temperature sensor is used as the sensor 80, a temperature is detected as a predetermined quantity A of state. There is, for example, an amount of heat to be dissipated as a parameter relating to the sensor installation portion 82 having a dependency on the temperature that is this quantity A of state. The distribution of the amount of heat to be dissipated in the first specific direction Da may be adjusted in a case where the variation range ΔA of the distribution of the quantity A of state of the sensor installation portion 82 in the first specific direction Da (the axial direction X) is to be reduced. For example, the amount of heat to be dissipated is increased at a portion where a temperature is high in the first specific direction Da, and the amount of heat to be dissipated is reduced at a portion where a temperature is low in the first specific direction Da to reduce the variation range ΔA of the distribution of the quantity A of state (temperature) in the first specific direction.

In a case where the distribution of the parameter (the amount of heat to be dissipated) having a dependency on the temperature in the first specific direction Da (the axial direction X) is to be adjusted in this way, the distribution of either the dimension or the physical property of a material of the sensor installation portion 82 in the second specific direction Db (the radial direction) is adjusted. For example, a fin portion extending in the second specific direction Db (the radial direction) may be provided in the sensor installation region 86 of the sensor installation portion 82 to adjust the dimension of the sensor installation portion 82 in the second specific direction Db. In a case where the fin portion is provided to adjust the amount of heat to be dissipated, for example, the height, the density, or the like of the fin portion is adjusted to adjust the amount of heat to be dissipated. The amount of heat to be dissipated can be increased as the height of the fin portion is increased or the density of the fin portion is increased, and the amount of heat to be dissipated can be reduced as the height of the fin portion is reduced or the density of the fin portion is reduced. In addition, a physical property (for example, thermal resistance) related to the amount of heat to be dissipated may be adjusted as the distribution of the physical property of the material of the sensor installation portion 82 in the first specific direction Da. For example, the amount of heat to be dissipated can be increased as the thermal resistance is reduced, and the amount of heat to be dissipated can be reduced as the thermal resistance is increased.

Next, an example in which an acceleration sensor is used as the sensor 80 and the casing 18 is used as the sensor installation member 84 will be described as another example of the combination of the sensor installation member 84 and the sensor 80. Here, an example in which the tubular portion of the casing 18 is the sensor installation portion 82, the outer peripheral surface of the casing 18 is the sensor installation region 86, the axial direction X is the first specific direction Da, and the radial direction is the second specific direction Db as in the example of the temperature sensor will be described. As described above, a distribution of the quantity A of state (acceleration), which is detected by the sensor 80, in the first specific direction Da (the axial direction X) varies in a case where the sensor installation portion 82 satisfies the reference condition and in a case where the sensor installation portion 82 is in a predetermined use environment.

In a case where an acceleration sensor is used as the sensor 80, acceleration is detected as a predetermined quantity A of state. Stiffness is a parameter relating to the sensor installation portion 82 having a dependency on the acceleration that is this quantity A of state. The stiffness mentioned here does not mean the stiffness of the sensor installation portion 82 of the sensor installation member 84 itself, but means the stiffness of the entire structure in which the sensor installation member 84 and peripheral members are combined. The distribution of the stiffness in the first specific direction Da may be adjusted in a case where the variation range ΔA of the distribution of the quantity A of state of the sensor installation portion 82 in the first specific direction Da (the axial direction X) is to be reduced. The acceleration can be reduced as the stiffness is increased, and the acceleration can be increased as the stiffness is reduced. For example, the stiffness is increased at a portion where acceleration is high in the first specific direction Da, and the stiffness is reduced at a portion where acceleration is low to reduce the variation range ΔA of the distribution of the quantity A of state (acceleration) in the first specific direction.

In a case where the distribution of the parameter (stiffness) having a dependency on the acceleration in the first specific direction Da (the axial direction X) is to be adjusted in this way, the distribution of either the dimension or the physical property of a material of the sensor installation portion 82 in the second specific direction Db (the radial direction) is adjusted. For example, the thickness of the sensor installation portion 82 in the second specific direction Db (the radial direction) may be adjusted to adjust the stiffness. The stiffness can be increased as the thickness in the second specific direction (the radial direction) is increased, and the stiffness can be reduced as the thickness in the second specific direction is reduced. As an example, a portion of the casing 18 that overlaps the main bearing 36 in the radial direction has high stiffness, and a portion farther from the main bearing 36 in the first specific direction (the axial direction) has low stiffness. Therefore, as a distance from the portion of the casing 18 overlapping the main bearing 36 in the radial direction is increased, the thickness of the sensor installation portion 82 in the second specific direction Db may be increased to increase the stiffness of a portion having low stiffness. As a result, the variation range ΔA of the distribution of the quantity A of state (acceleration) in the first specific direction may be reduced. In addition, a physical property (for example, Young's modulus) related to the stiffness may be adjusted as the distribution of the physical property of the material of the sensor installation portion 82 in the first specific direction Da. For example, the stiffness can be increased as the Young's modulus is increased, and the stiffness can be reduced as the Young's modulus is reduced.

Next, modification examples of each component described so far will be described. Hereinafter, in a case where components (the internal gears and the like) of which the reference numerals have “A” or “B” at the ends thereof are collectively referred to, “A” or “B” will be omitted.

A specific example of the gear device 10 is not particularly limited as long as the gear device 10 includes the external gear 26 and the internal gear 28 that mesh with each other. For example, the gear device 10 may be an eccentric oscillation type gear device, a simple planetary gear device, or the like in addition to a bending meshing type gear device. Further, the eccentric oscillation type gear device may be a distribution type in which a crankshaft is disposed at a position offset from an axial center of a meshing gear in addition to a center crank type in which a crankshaft is disposed on an axial center of a meshing gear that meshes with an oscillating gear.

Furthermore, a specific example of the bending meshing type gear device is not particularly limited, and may be, for example, a cup type or a silk hat type. In addition, in a case of the bending meshing type gear device, the internal gears 28A and 28B may be bending gears.

The installation positions of the strain sensors 50 on the easily deformable portion 44 are not particularly limited. The strain sensors 50 may be installed on any one of both side surfaces of the easily deformable portion 44 in the axial direction, or may be installed on peripheral surfaces thereof in a case where the easily deformable portion 44 is a plurality of pillar portions 70.

In a case where the radial distribution of the axial thickness of the easily deformable portion 44 is to be changed and the easily deformable portion 44 satisfies a condition in which the variation range of the radial distribution of the strain is made small as compared to a case where the easily deformable portion 44 is in the reference condition, a configuration in which the axial thickness is gradually reduced is not essential. In a case where the easily deformable portion 44 satisfies this condition, the easily deformable portion 44 may include, for example, a portion of which an axial thickness is increased in addition to a portion of which an axial thickness is gradually reduced from the radially inner side to the radially outer side.

The installation surface 52 of the easily deformable portion 44 may be inclined with respect to the axial direction. In this case, the opposite surface 54 may be inclined with respect to the axial direction, or the opposite surface 54 may be perpendicular to the axial direction.

The gear device 10 may not include the protection material 62. The first internal gear 28A may not include the recessed portion 60 in which the protection material 62 is to be provided.

The sensor installation member 84 has been described so far as an example of a component part used in the gear device 10. However, a specific example of the sensor installation member 84 is not particularly limited and may be a component part for various mechanical devices other than the gear device 10. The mechanical device may be, for example, a power transmission device (including the gear device 10), such as a motor or an actuator, or may be a load cell or the like, in addition to the gear device 10.

The above-described embodiments and modification examples are exemplary. The technical ideas that abstract these should not be construed as being limited to the contents of the embodiments and the modification examples. Many design changes, such as a change, addition, and deletion of a component, are possible with respect to the contents of the embodiments and the modification examples. In the embodiments described above, the expression of “embodiment” is added to emphasize the contents that allow such design changes. However, design changes are allowed even in the contents in which there is no such expression. Hatching applied to a cross-section in the drawing does not limit the material of a hatched object. Naturally, the structures/numerical values mentioned in the embodiments and the modification examples can be regarded as the same in consideration of manufacturing errors or the like.

Any combination of the components described above is also effective. For example, any description item of one embodiment may be combined with another embodiment, or any description item of the embodiments and any description item of one modification example may be combined with another modification example.

The present invention relates to a gear device and a sensor installation member.

It should be understood that the invention is not limited to the above-described embodiment, but may be modified into various forms on the basis of the spirit of the invention. Additionally, the modifications are included in the scope of the invention.

What is claimed is:

1. A gear device comprising:
an internal gear; and
an external gear that meshes with the internal gear,
wherein the internal gear includes
an internal tooth ring portion that is provided with internal teeth on an inner periphery thereof,
an outer ring portion that is provided on a radially outer side of the internal tooth ring portion, and
an easily deformable portion that is provided between the internal tooth ring portion and the outer ring portion and that is adapted to be more easily deformable than the internal tooth ring portion,
a strain sensor is installed on the easily deformable portion, and
the easily deformable portion is adapted such that a variation range of a radial distribution of strain is small as compared to a case where the easily deformable portion is made of a single material to have a uniform axial thickness in a radial direction.

2. The gear device according to claim 1,
wherein the axial thickness of the easily deformable portion is changed in the radial direction.

3. The gear device according to claim 2,
wherein the axial thickness of the easily deformable portion is gradually reduced from a radially inner side to a radially outer side.

4. The gear device according to claim 3,
wherein an installation surface of the easily deformable portion on which the strain sensor is installed is perpendicular to an axial direction, and an opposite surface of the easily deformable portion positioned on a side opposite to the installation surface in the axial direction is inclined with respect to the axial direction.

5. The gear device according to claim 1,
wherein the easily deformable portion has a ring shape.

6. The gear device according to claim 5, further comprising:
a protection material which is provided on the easily deformable portion and in which the strain sensor is buried.

7. The gear device according to claim 6,
wherein the internal gear includes a recessed portion that is provided on the easily deformable portion and that is recessed in the axial direction, and
the protection material is provided in the recessed portion.

8. The gear device according to claim 1,
wherein the easily deformable portion is a plurality of pillar portions provided at intervals in a circumferential direction.

9. A sensor installation member comprising:
a sensor installation portion on which a sensor for detecting a predetermined quantity of state is to be installed,
wherein the sensor installation portion is adapted such that a variation range of a distribution of the quantity of state in a specific direction is small as compared to a case where the sensor installation portion is made of a single material such that a dimension of the sensor installation portion in a direction perpendicular to the specific direction is uniform in the specific direction, and
the sensor installation portion includes a sensor installation region having a range larger than a size of the sensor and is adapted such that the sensor is installable at any position of the sensor installation region in the specific direction.
